(19) United States
(12) Patent Application Publication
(10) Pub. No.: US 2024/0204527 A1
(43) Pub. Date: Jun. 20, 2024

(54) SYSTEMS AND METHODS FOR MINIMIZING GRID-BASED ENERGY CONSUMPTION

(71) Applicant: FORD GLOBAL TECHNOLOGIES, LLC, Dearborn, MI (US)

(72) Inventors: Stuart C. SALTER, White Lake, MI (US); Ryan O'GORMAN, Beverly Hills, MI (US); Brendan DIAMOND, Grosse Pointe, MI (US)

(21) Appl. No.: 18/067,938

(22) Filed: Dec. 19, 2022

(51) Int. Cl. H02J 3/32; B60L 53/68; B60L 55/00; G05B 19/042; H02J 3/00; H02J 3/38; H02J 7/00

(52) U.S. Cl. CPC H02J 3/322; B60L 53/68; B60L 55/00; G05B 19/042; H02J 3/004; H02J 3/381; H02J 7/0071; B60L 53/51; G05B 2219/2639; H02J 2300/22

(57) ABSTRACT

Systems and methods are provided for controlling a vehicle-to-home power supply and energy storage system in a manner that minimizes grid-based energy consumption without disrupting future usage of a vehicle of the system. A control system of the system may be configured to estimate a renewable energy generation of a local renewable energy system based on crowd sourced renewable energy generation information and weather information. The control module may be further configured to prepare a charging/discharging schedule and a vehicle operating schedule based on the estimated renewable energy generation of the local renewable energy system.

### TECHNICAL FIELD

This disclosure relates generally to the field of vehicle-to-home bidirectional-capable power supply and energy storage systems, and more particularly to vehicle-to-home systems designed for minimizing grid-based energy consumption.

### BACKGROUND

Plug-in type electrified vehicles include one or more charging interfaces for charging a traction battery pack. The traction battery pack must be periodically recharged to replenish the energy levels necessary for achieving vehicle propulsion. Many plug-in vehicle owners are environmentally conscious.

### SUMMARY

A vehicle-to-home power supply and energy storage system according to an exemplary aspect of the present disclosure includes, among other things, a local renewable energy system, and a control module programmed to estimate an amount of renewable energy expected to be generated by the local renewable energy system over a predefined time period based on a crowd sourced renewable power generation data and a weather data.

In a further non-limiting embodiment of the foregoing system, the local renewable energy system includes at least one solar panel.

In a further non-limiting embodiment of either of the foregoing systems, the crowd sourced renewable power generation data is received from a crowd sourced database of a cloud-based server system.

In a further non-limiting embodiment of any of the foregoing systems, the weather data is received from a weather database of cloud-based server system.

In a further non-limiting embodiment of any of the foregoing systems, the weather data includes at least a speed and a direction of wind or an amount of cloud coverage.

In a further non-limiting embodiment of any of the foregoing systems, the control module is further programmed to prepare a charging/discharging schedule for transferring energy from the local renewable energy system.

In a further non-limiting embodiment of any of the foregoing systems, the charging/discharging schedule is at least partially derived based on the amount of renewable energy expected to be generated by the local renewable energy system over the predefined time period.

In a further non-limiting embodiment of any of the foregoing systems, the charging/discharging schedule is further derived based on a total energy need of a structure associated with the local renewable energy system.

In a further non-limiting embodiment of any of the foregoing systems, the charging/discharging schedule includes instructions for charging a vehicle of the system.

In a further non-limiting embodiment of any of the foregoing systems, the control module is further configured to create a vehicle operating schedule for operating a vehicle of the system.

In a further non-limiting embodiment of any of the foregoing systems, the vehicle operating schedule includes a target departure time for leaving a home location of the vehicle and a target return time for returning to the home location.

In a further non-limiting embodiment of any of the foregoing systems, the control module is programmed to select the target departure time during a period of time in which the amount of renewable energy expected to be generated by the local renewable energy system exceeds a predefined threshold.

A vehicle-to-home power supply and energy storage system according to another exemplary aspect of the present disclosure includes, among other things, a vehicle including a traction battery pack, a local renewable energy system configured to selectively provide power for charging the traction battery pack, and a control module programmed to schedule a drive route of the vehicle to occur during a time period in which a renewable energy generation of the local renewable energy system is expected to exceed a predefined threshold.

In a further non-limiting embodiment of the foregoing system, the control module is an on-board component of the vehicle.

In a further non-limiting embodiment of either of the foregoing systems, the renewable energy generation of the local renewable energy system is derived from a crowd sourced renewable power generation data.

In a further non-limiting embodiment of any of the foregoing systems, the renewable energy generation of the local renewable energy system is further derived from a weather data.

In a further non-limiting embodiment of any of the foregoing systems, the weather data includes wind information or cloud coverage information.

In a further non-limiting embodiment of any of the foregoing systems, the control module is programmed to identify a target departure time for the vehicle to travel away from a home location of the vehicle and a target return time for the vehicle to return to the home location as part of scheduling the drive route.

In a further non-limiting embodiment of any of the foregoing systems, the control module is programmed to identify a charging location along the drive route as part of scheduling the drive route.

In a further non-limiting embodiment of any of the foregoing systems, the time period correlates to a period of relatively low cloud coverage at a location of the local renewable energy system.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a vehicle-to-home power supply and energy storage system.

FIG. 2 schematically illustrates a control system of the vehicle-to-home power supply and energy storage system.

FIG. 3 illustrates another exemplary control system for a vehicle-to-home power supply and energy storage system.

FIG. 4 illustrates a user interface for providing information to a user related to a vehicle operating schedule as part of a vehicle-to-home power supply and energy storage system.

FIG. 5 schematically illustrates a graphical plot of an estimated renewable energy generation of a local renewable energy system over time.

FIG. 6 is a flow chart of an exemplary method for controlling a vehicle-to-home power supply and energy storage system in a manner that minimizes grid-based energy consumption.

### DETAILED DESCRIPTION

This disclosure relates to systems and methods for controlling a vehicle-to-home power supply and energy storage system in a manner that minimizes grid-based energy consumption without disrupting future usage of a vehicle of the system. A control system of the system may be configured to estimate a renewable energy generation of a local renewable energy system based on crowd sourced renewable energy generation information and weather information. The control module may be further configured to prepare a charging/discharging schedule and a vehicle operating schedule based on the estimated renewable energy generation of the local renewable energy system. These and other features of this disclosure are discussed in greater detail in the following paragraphs of this detailed description.

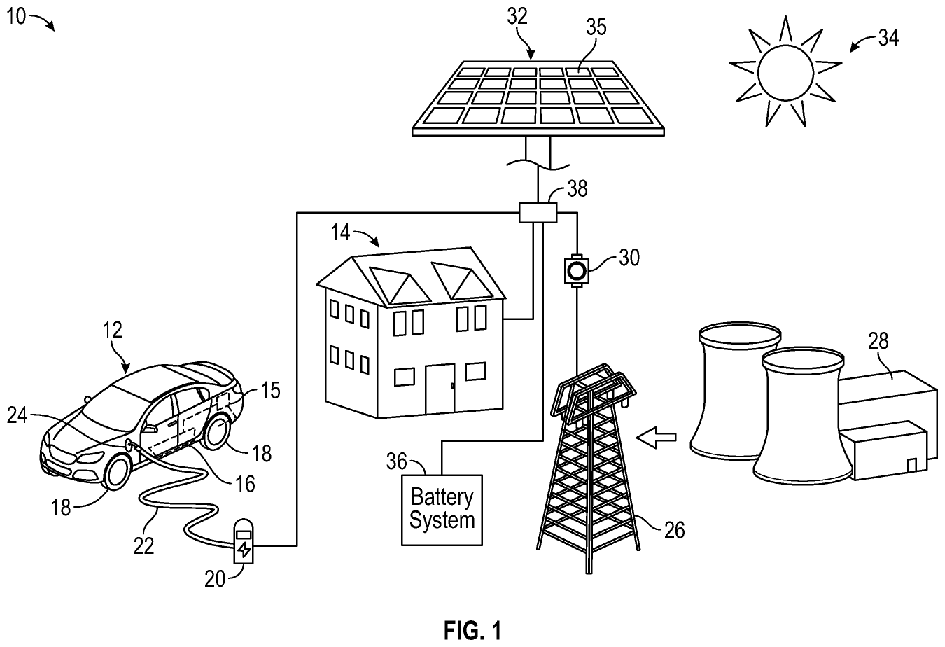

FIG. 1 schematically illustrates a vehicle-to-home power supply and energy storage system 10 (hereinafter “the system 10”) for bidirectionally transferring energy between a vehicle 12 and a structure 14. The system 10 enables the bidirectional transfer of energy from the vehicle 12 to the structure 14 and vice versa. The structure 14 may be a residential building, a commercial building, a parking garage, or any other type of structure that is capable of receiving or transferring energy. In an embodiment, the structure 14 is a residential household that functions as a “home location” of the vehicle 12.

Although a specific component relationship is illustrated in the figures of this disclosure, the illustrations are not intended to limit this disclosure. The placement and orientation of the various components of the depicted system are shown schematically and could vary within the scope of this disclosure. In addition, the various figures accompanying this disclosure are not necessarily drawn to scale, and some features may be exaggerated or minimized to emphasize certain details of a particular component.

In an embodiment, the vehicle 12 is a plug-in type electric vehicle (e.g., a plug-in hybrid electric vehicle (PHEV) or a battery electric vehicle (BEV)). The vehicle 12 includes a traction battery pack 16 that is part of an electrified powertrain capable of applying a torque from an electric machine 15 (e.g., an electric motor) for driving wheels 18 of the vehicle 12. Therefore, the electrified powertrain of the vehicle 12 may electrically propel the set of drive wheels 18 either with or without the assistance of an internal combustion engine.

The vehicle 12 of FIG. 1 is schematically illustrated as a car. However, other vehicle configurations are also contemplated. The teachings of this disclosure may be applicable for any type of vehicle as the vehicle 12. For example, the vehicle 12 could be configured as a car, a truck, a van, a sport utility vehicle (SUV), etc.

Although shown schematically, the traction battery pack 16 may be configured as a high voltage traction battery pack that includes a plurality of battery arrays (e.g., battery assemblies or groupings of battery cells) capable of outputting electrical power to one or more electric machines of the vehicle 12. Other types of energy storage devices and/or output devices may also be used to electrically power the vehicle 12.

The vehicle 12 may interface with the structure 14 through a charging station 20 (e.g., a wall box or other structure) in order to perform bidirectional energy transfers of the system 10. In an embodiment, the charging station 20 is a bidirectional charging station. A charge cable 22 may operably connect the charging station 20 to a charge port assembly 24 of the vehicle 12 for transferring energy between the vehicle 12 and the structure 14. The charge cable 22 may be configured to provide any level of charging (e.g., 120 VAC, 240 VAC, Direct Current (DC) charging, etc.). The vehicle 12 may be equipped with the necessary components (e.g., a charger, a converter, HV relays or contactors, a motor controller, etc.) for performing bidirectional energy transfers as part of the system 10 when operably connected to the charging station 20.

Electrical energy from a grid power source 26 can be used to power the structure 14 and/or charge the traction battery pack 16 of the vehicle 12. In an embodiment, the grid power source 26 is owned and operated by a utility company. A plurality of power stations 28 can produce electrical energy for the grid power source 26. To produce electrical energy, the power stations 28 could include generators driven by heat engines that are fueled by burning fossil fuels, nuclear fission, flowing water, or wind. When driven, the generators produce electrical energy. In some implementations, the power stations 28 could instead or additionally generate electrical energy from geothermic or solar sources.

The grid power source 26 is an interconnected network for delivering electrical energy to various locations, including the structure 14. The grid power source 26 may be referred to as main electricity, grid power, or wall power.

The grid power source 26 may connect to the structure 14 through a grid meter 30. The utility company can use the grid meter 30 to assess the amount of electrical energy provided to the structure 14 from the grid power source 26.

Electrical energy from a local renewable energy system 32 can alternatively or additionally provide electrical power to the structure 14 and/or the vehicle 12. The local renewable energy system 32 can generate electrical energy from a renewable source 34 (e.g., solar, wind, hydroelectric). In an embodiment, the local renewable energy system 32 includes one or more solar panels 35.

The electrical energy generated by the local renewable energy system 32 may be used locally by the structure 14 or can feed electrical energy into the grid power source 26. Electrical energy generated by the local renewable energy system 32 may also be stored locally within a battery system 36 of the structure 14.

The local renewable energy system 32 may be separated from the grid power source 26 by the grid meter 30, which can be considered a boundary between the grid power source 26 and the local renewable energy system 32. A person having skill in this art and the benefit of this disclosure would understand how the grid power source 26 differs from the local renewable energy system 32.

Electrical energy from the grid power source 26, the local renewable energy system 32, or both can be used to power the charging station 20. The traction battery pack 16 of the vehicle 12 can therefore be recharged from the grid power source 26, the local renewable energy system 32, or both.

In some situations, the charging station 20 may be configured to transfer electrical energy from the vehicle 12 to the structure 14. For example, in a power outage or blackout, the utility company is unable to provide electrical energy through the grid meter 30 to the structure 14. Therefore, transferring energy from the local renewable energy system 32 and/or the vehicle 12 to the structure 14 may be required during the power outage/blackout conditions.

A transfer switch 38 may be transitioned when the vehicle 12, the local renewable energy system 32, and/or the battery system 36 is providing electrical energy to the structure 14. The transitioning of the transfer switch 38 can electrically decouple the structure 14 and its associated electrical loads from the grid power source 26 and/or any other power source when power from the respective power source(s) is not desired or is unavailable.

The traction battery pack 16 of the vehicle 12 and/or the battery system 36 of the structure 14 may be used to locally store electrical energy for use by the structure 14, such as during blackouts or when grid power source 26 rates are higher, etc. Therefore, the traction battery pack 16 and the battery system 36 may together function as a backup energy storage system for powering the electrical loads of the structure 14. This reduces reliance on the grid power source 26.

The owner/user of the vehicle 12 and/or structure 14 may consider themselves to be an environmentally conscious person. The owner/user may therefore wish to power the structure 14 and charge the vehicle 12 in ways that are as environmentally friendly as possible. This disclosure is therefore directed to systems and methods for minimizing energy consumption from the grid power source 26, even during times when energy contributions from the local renewably energy system 32 are reduced such as due to cloud coverage or other factors, and without disrupting future usage of the vehicle 12.

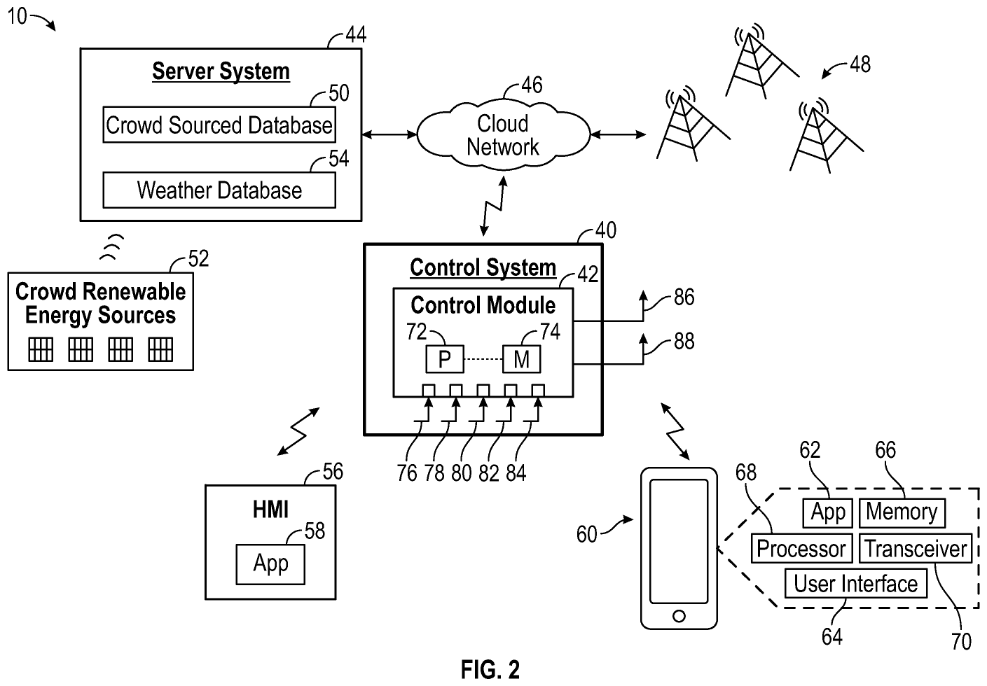

FIG. 2 schematically depicts additional functionality of the system 10 of FIG. 1. The system 10 may be specifically configured to estimate an amount of renewable energy that can be produced by the local renewable energy system 32 over various future time horizons, and based on this estimate, coordinate charging/discharging events of the system 10 and trips of the vehicle 12 in a manner that minimizes or even completely eliminates reliance on the grid power source 26.

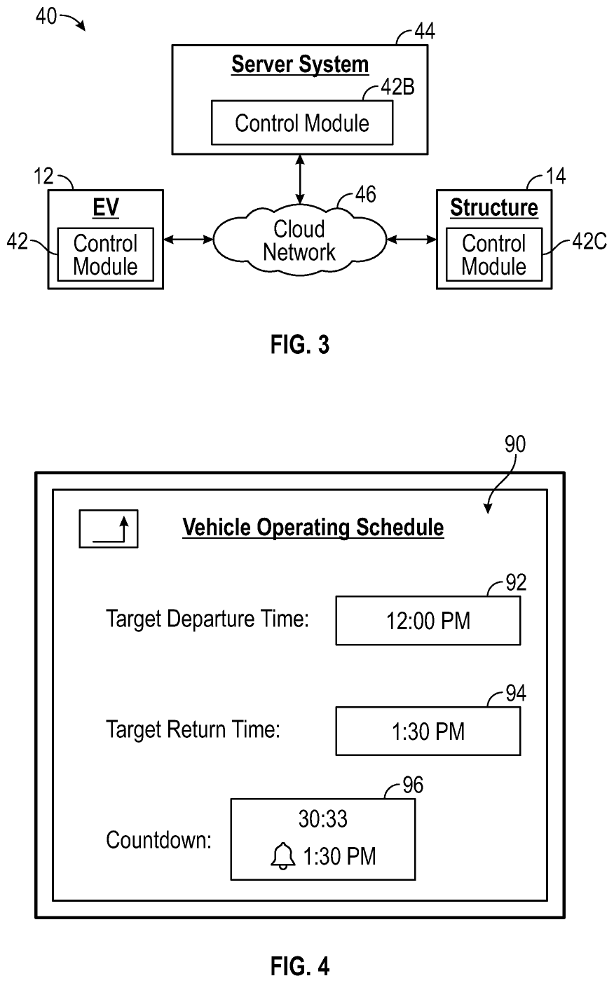

The system 10 may include a control system 40 that includes one or more control modules 42 that may be programmed to execute various control strategies of the system 10. In an embodiment, the control module 42 of the control system 40 is an on-board component of the vehicle 12. However, other embodiments are also contemplated within the scope of this disclosure. For example, a control module 42B of a server system 44 (e.g., a cloud-based control module) and/or a control module 42C associated with the structure 14 could be configured to function as the communications hub of the system 10. In yet another embodiment, the control module 42 of the vehicle 12, the control module 42B of the server system 44, and the control module 42C of the structure 14 may operate together over a cloud network 46 (e.g., the internet) to establish the control system 40 for controlling the functionality of the system 10 (see, e.g., FIG. 3).

The control system 40 may communicate with server system 44 over the cloud network 46 to obtain various information stored on the server system 44 or to provide information to the server system 44 that can subsequently be accessed by the vehicle 12 and/or the structure 14. The server system 44 can identify, collect, and store user data associated with the vehicle 12 and/or the structure 14 for validation purposes. Upon an authorized request, data may be subsequently transmitted to the control system 40 via one or more cellular towers 48 or some other known communication technique (e.g., Wi-Fi, Bluetooth®, data connectivity, etc.). The control system 40 may be configured to both receive data from the server system 44 and communicate data back to the server system 44 via the cellular tower(s) 48. Although not necessarily shown or described in this highly schematic embodiment, numerous other components may enable bidirectional communications between the control system 40 and the server system 44 as part of executing the various functions of the system 10.

The server system 44 may include various databases that store data that may be accessed by the control system 40 in anticipation of performing functionality associated with the system 10, such as for estimating an amount of renewable energy that can be produced by the local renewable energy system 32 of the structure 14 over various future time horizons (e.g. 10 minutes, 30 minutes, 60 minutes, 12 hours, 24 hours, 1 week, etc.), for example.

In an embodiment, the server system 44 includes a crowd sourced database 50 for storing information from a plurality of crowd renewable energy sources 52. Generally, the crowd renewable energy sources 52 include solar panels or other renewable energy sources of homes or buildings that are located within a common geographical region as the structure 14. The geographical region may be defined to be any desired size, and could be delineated in terms of a city, a state, a region, etc. The local renewable energy system 32 of the structure 14 may be one of the crowd renewable energy sources 52. The crowd renewable energy sources 52 may wirelessly communicate with the server system 44 via the cellular towers 48 or some other known communication technique (e.g., Wi-Fi, Bluetooth®, data connectivity, etc.).

The crowd sourced database 50 may be populated with renewable power generation data received from each member of the crowd renewable energy sources 52. The renewable power generation data may include information such as the geographic location of each member of the crowd renewable energy sources 52, an amount (e.g., in kilowatt-hours (kWh)) of renewable power generation occurring at each member of the crowd renewable energy sources 52, the date and time of the recorded renewable power generation, etc. The renewable power generation data can be updated in real-time based on communications with each member of the crowd renewable energy sources 52.

In another embodiment, the server system 44 includes a weather database 54 that stores weather related data. The weather related data may include, but is not limited to, weather history including historic weather data for a given geographical area, current and forecasted windspeeds, current and forecasted temperatures, current and forecasted sun-loads, current and forecasted cloud coverage, current and forecasted rain fall or snowfall, etc.

The weather data database 54 may be operated or managed, for example, by an organization such as the national weather service. Alternatively, the server system 44 may collect weather/climate related data from weather stations, news stations, remote connected temperature sensors, connected mobile device database tables, etc., for populating the weather database 54.

In an embodiment, a user/owner of the vehicle 12 and/or structure 14 may interface with the system 10 for coordinating functions of the system 10 or for receiving information concerning the system 10 using a human machine interface (HMI) 56 of the vehicle 12. For example, the HMI 56 may be equipped with an application 58 (e.g., Sync® or another similar application) for allowing users to interface with the system 10. The HMI 56 may be located within a passenger cabin of the vehicle 12 and may include various user interfaces for displaying information to the vehicle occupants and for allowing the vehicle occupants to enter information into the HMI 56. The user may interact with the user interfaces presentable on the HMI 56 via touch screens, tactile buttons, audible speech, speech synthesis, etc.

In another embodiment, the user/owner of the vehicle 12 and/or the structure 14 may alternatively or additionally interface with the system 10 using a personal electronic device 60 (e.g., a smart phone, tablet, computer, wearable smart device, etc.). The personal electronic device 60 may include an application 62 (e.g., FordPass™ or another similar application) that includes programming to allow the user to employ one or more user interfaces 64 for setting or controlling certain aspects of the system 10. The application 62 may be stored in a memory 66 of the personal electronic device 60 and may be executed by a processor 68 of the personal electronic device 60. The personal electronic device 60 may additionally include a transceiver 70 that is configured to communicate with system 10 and the sever system 44 over the cellular tower(s) 48 or some other wireless link.

Each control module 42 of the control system 40 may include both hardware and software. In an embodiment, each control module 42 is programmed with executable instructions for interfacing with and commanding operation of various components of the system 10.

Each control module 42 may include a processor 72 and non-transitory memory 74 for executing various control strategies and modes associated with the system 10. The processor 72 may be a custom made or commercially available processor, a central processing unit (CPU), or generally any device for executing software instructions. The memory 74 may include any one or combination of volatile memory elements and/or nonvolatile memory elements. The processor 72 may be operably coupled to the memory 74 and may be configured to execute one or more programs stored in the memory 74 of the control module 42 based on the various inputs received from other devices, such as the server system 44, the vehicle 12, the structure 14, etc.

Each control module 42 of the control system 40 may receive and process various inputs for controlling the system 10. A first input to the control system 40 may include household information 76 associated with the structure 14. The household information 76 may include historical energy usage (e.g., energy logs) of the structure 14, smart meter readings (e.g., current consumption of total energy in readings through voltage, current, and power factor levels), smart appliance information (e.g., status of appliance use, notifications, energy profiles, energy use per unit of appliance usage, etc.), other appliance inputs (e.g., current sensor and temperature sensor information, etc.), customer preference information (e.g., customer energy transfer settings), etc.

The household information 76 may alternatively or additionally include crowd sourced energy usage statistics from homes or buildings that are similar to the structure 14. For example, the crowd sourced energy usage statistics may be from homes or buildings that are similar to the structure 14 in terms of size, number of occupants, location (e.g., by zip code), average expected temperature, average home temperature, etc.

Another input to the control system 40 may include vehicle information 78 received from the vehicle 12. The vehicle information 78 may include information such as the current charging status of the vehicle (e.g., on-plug versus off-plug, current power transfer rate if on-plug, etc.), current state of charge (SOC) of the traction battery pack 16, estimated travel range of the vehicle 12, available bidirectional energy transfer capability of the traction battery pack 16, trip planner information (e.g., expected drive routes planned by the user), average distance driven per day, average energy consumption based on factors such as vehicle speed and ambient temperature, etc.

Another input to the control system 40 may include user preference information 80 that may be pre-selected by the user of the system 10. The user preference information 80 may include a minimum SOC requirement for the vehicle 12 (e.g., maintain traction battery pack 16 SOC above 80%), a minimum energy storage amount stored in the battery system 36, a minimum energy usage from the local renewable energy system 32, a maximum energy usage from the grid power source 26, etc. The user preference information 80 may be entered by the user via the HMI 56 and/or the personal electronic device 60, for example.

Another input to the control module 42 may include renewable energy generation information 82 received from the crowd sourced database 50 of the server system 44. The renewable energy generation information 82 may include historical and current renewable energy generation for each solar panel of the crowd renewable energy sources 52. The renewable energy generation information 82 may further include expected renewable energy generation for each member of the crowd renewable energy sources 52 over various durations of time (e.g., 10 minutes, 30 minutes, 60 minutes, 12 hours, 24 hours, 1 week, etc.).

Yet another input to the control module 42 may include weather information 84 received from the weather database 54. Among other information, the weather information 84 may include wind, sun-load, and general temperature/weather forecast conditions at the location of the structure 14.

Based at least on the household information 76 and the user preference information 80, the control module 42 of the control system 40 may be programmed to estimate a total energy need of the structure 14 for each of a plurality of future time periods (e.g., 10 minutes, 30 minutes, 60 minutes, 12 hours, 24 hours, 1 week, etc.). The total energy need represents the total amount of energy required to power the electrical loads of the structure 14 for a given time period. The total energy need may be based on learned energy usage averages in which the control module 42 may employ statistical methodologies (e.g., rolling average, standard of deviation, etc.) to constantly monitor energy usage trends and correlate those trends with the household information 76 for accurately estimating the total energy needs of the structure 14.

Based at least on the vehicle information 78 and the user preference information 80, the control module 42 of the control system 40 may be programmed to estimate a total energy need of the vehicle 12 for each of a plurality of future time periods (e.g., 10 minutes, 30 minutes, 60 minutes, 12 hours, 24 hours, 1 week, etc.). The total energy need represents the total amount of energy required to power the vehicle 12 for a given time period based on planned or inferred usage of the vehicle 12.

Based at least on the renewable energy generation information 82 and the weather information 84, the control module 42 of the control system 40 may be programmed to estimate an expected renewable energy generation of the local renewable energy system 32 for each of the plurality of future time periods (e.g., 10 minutes, 30 minutes, 60 minutes, 12 hours, 24 hours, 1 week, etc.). For example, knowing factors such as the average renewable energy generation of upwind solar panels for each time period, the direction and speed of wind/cloud movement, the distance of the structure 14 from upwind solar panels, etc., the control module 42 may accurately predict the amount of renewable energy that is likely to be generated by the local renewable energy system 32 for each desired future time period.

The control module 42 may be further programmed to compare the expected renewable energy generation of the local renewable energy system 32 with the total energy needs of the vehicle 12 and the structure 14 to determine whether the system 10 has a renewable energy surplus or a renewable energy deficit for meeting the energy needs of the system 10 without consuming energy from the grid power source 26.

Based on the various comparisons described above, the control module 42 may create a charging/discharging schedule 86 for transferring energy within the system 10. The charging/discharging schedule 86 may include instructions (e.g., energy transfer protocols, etc.) for transferring energy throughout the system 10 during each of the future time periods in a manner that best minimizes energy consumed from the grid power source 26. The charging/discharging schedule 86 will only request energy from the grid power source 26 when necessary to fill energy gaps or to meet specific user energy demand requirements indicated by the user preference information 80. In the event a renewable energy surplus is identified, the charging/discharging schedule 86 may further include instruction for storing the excess renewable energy from the local renewable energy system 32 in the traction battery pack 16 of the vehicle 12 and/or the battery system 36.

The charging/discharging schedule 86 may further include instructions for selectively reducing the energy consumption of the structure 14. For example, the control module 42 may automatically command the structure 14 to reduce power consumption (e.g., by turning off or postponing operation of certain appliances) and power the structure using power from the traction battery pack 16 and/or the battery system 36 when renewable energy generation by the local renewable energy system 32 is below a predefined threshold (such as when cloud coverage is high, for example).

The charging/discharging schedule 86 may also include instructions for reducing the energy consumption of the structure 14 when the vehicle 12 is away from the structure 14 and the renewable energy generation of the local renewable energy system 32 is insufficient to meet the total energy needs of the structure 14.

The control module 42 of the control system 40 may be further programmed to create a vehicle operating schedule 88 for operating the vehicle 12. Among other things, the vehicle operating schedule 88 may identify optimal time periods during which it is most appropriate for the vehicle 12 to leave the structure 14, such as for running errands, for example. The vehicle operating schedule 88 may be derived, at least in part, based on the expected renewable energy generation of the local renewable energy system 32 and expected weather conditions at the location of the structure 14. The local renewable energy system 32 is most capable of supporting the electrical loads of the structure 14 (without assistance from the vehicle 12) when cloud coverage is lower as opposed to higher. The vehicle operating schedule 88 may therefore leverage this information in order to correlate areas of expected lower cloud coverage with times periods in which it is more optimal for the vehicle 12 to travel away from the structure 14 and still avoid grid-based power consumption.

The vehicle operating schedule 88 may identify one or more target departure times/time windows and target return times/time windows of the vehicle 12. If possible, the target departure and return times identified within the vehicle operating schedule 88 may be chosen such that the local renewable energy system 32 and the battery system 36 are capable of supporting the energy needs of the structure 14 while the vehicle 12 is away without reliance on the grid power source 26.

The vehicle operating schedule 88 may further include instructions for charging the traction battery pack 16 of the vehicle 12 to a predefined level by the target departure time. These instructions may include protocols for charging the traction battery pack 16 only to the state of charge necessary for completing an expected drive route.

The vehicle operating schedule 88 may further include instructions for charging the vehicle 12 while it is away from the structure 14. For example, the vehicle operating schedule 88 may identify renewable energy charging stations located along or near a planned route of the vehicle 12 and may include instructions for charging the vehicle 12 at such locations during the expected drive route. The renewable energy used to charge the traction battery pack 16 may subsequently be brought back to the structure 14 in order to support the electrical loads of the structure 14 during subsequent high cloud coverage periods in which renewable energy generation is below a predefined threshold.

An exemplary user interface 90 that can be presented to the user on the HMI 56 and/or the personal electronic device 60 is schematically illustrated in FIG. 4. The user interface 90 may provide information to the user related to the vehicle operating schedule 88. For example, a target departure time 92 and a target return time 94 may be indicated within the user interface 90. The target departure time 92 indicates to the user when to leave the structure 14 and the target return time 94 indicates to the user when to return to the structure 14 in order to best minimize the need to draw energy from the grid power source 26.

The user interface 90 may additionally include a countdown timer 96. The countdown timer 96 may indicate in the real time the amount of time the user has left before the vehicle 12 needs to return to the structure 14 in order to best minimize energy consumption from the grid power source 26. The amount of time indicated by the countdown timer 96 may be calculated by subtracting a current time from the target return time.

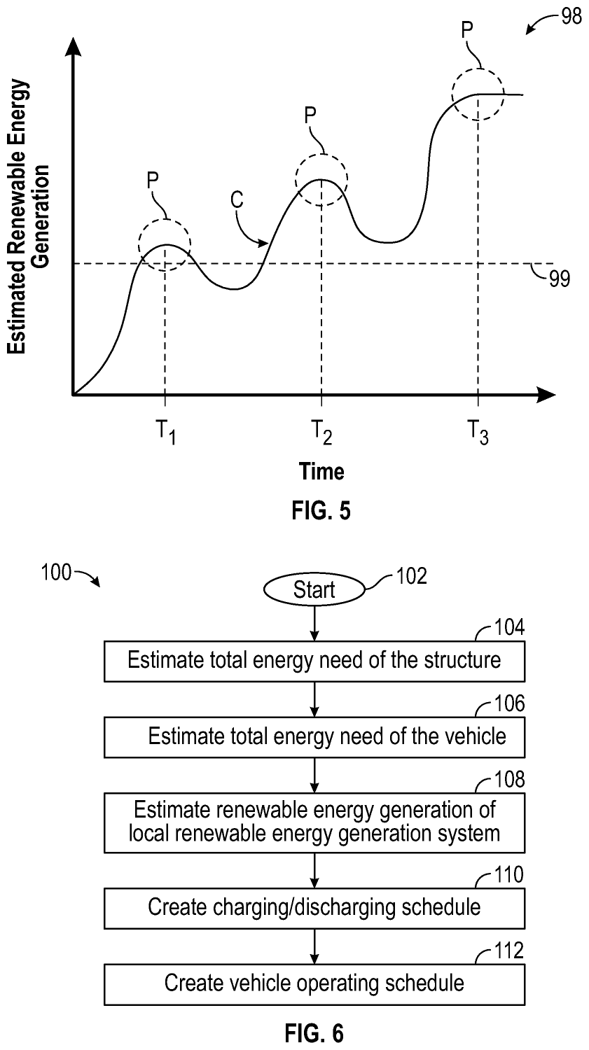

FIG. 5 schematically illustrates (in graphical form) a plot 98 of estimated renewable energy generation of the local renewable energy system 32 over time. The control module 42 may derive one or more target departure times of the vehicle operating schedule 88 based on the plot 98. For example, one or more energy generation peaks P can be identified along a curve C of the plot 98. Each peak P may correspond to a times in which the renewable energy generation of the local renewable energy system 32 exceeds a predefined energy generation threshold 99. Each peak P may thus also be associated with aa period of relatively low cloud coverage.

A time period associated with each of the peaks P therefore represents a window in which it may be the most appropriate for the vehicle 12 to travel away from the structure 14, such as for running errands, for example, and still minimize the need to utilize energy from the grid power source 26. In the illustrated example, the control module 42 may identify times T₁, T₂, or T₃ as optimal departure times because renewable energy generation of the local renewable energy system 32 exceeds the predefined energy generation threshold 99 at each of the times T₁, T₂, or T₃. The times T₁, T₂, and T₃ may be specific times or windows of time.

FIG. 6, with continued reference to FIGS. 1-5, schematically illustrates (in flow chart form) an exemplary method 100 for controlling the system 10 in a manner that minimizes energy consumed from the grid power source 26. The control system 40 may be configured to employ one or more algorithms adapted to execute at least a portion of the steps of the exemplary method 100. For example, the method 100 may be stored as executable instructions in the memory 74 of the control module 42, and the executable instructions may be embodied within any computer readable medium that can be executed by the processor 72 of the control module 42. The method 100 could alternatively or additionally be stored as executable instructions in the memories of the control module 42B of the server system 44 and/or the control module 42C of the structure 14.

The exemplary method 100 may begin at block 102. At block 104, the method 100 may estimate a total energy need of the structure 14 for each of a plurality of future time periods, and at block 106, the method 100 may estimate a total energy need of the vehicle 12 for each of the future time periods. A sum of the total energy need of the structure 14 and a total energy need of the vehicle 12 represents a total energy need of the system 10.

The method 100 may next, at block 108, estimate a renewable energy generation of the local renewable energy system 32 for each of the future time periods. As described above, the estimated renewable energy generation may be derived from crowd sourced renewable energy generation information 82 and the weather information 84.

The charging/discharging schedule 86 may be created at block 110 based on a comparison of the estimated renewable energy generation and the total energy need of the system 10. The charging/discharging schedule 86 may include instructions for transferring energy throughout the system 10 during each of the future time periods in a manner that best minimizes energy consumed from the grid power source 26.

Finally, the vehicle operating schedule 88 may be created at block 112. The vehicle operating schedule 88 may identify at least one target departure time and at least one target return time for operating the vehicle 12. The target departure times may correlate to periods in which the estimated renewable energy generation of the local renewable energy system 32 is expected to exceed the predefined energy generation threshold 99.

The systems and methods of this disclosure are designed to prioritize energy usage in a manner that minimizes or even completely eliminates reliance on grid power without disrupting planned usage of the vehicle 12. The proposed systems/methods are designed to provide increased customer satisfaction, particularly for environmentally conscious vehicle owners.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle-to-home power supply and energy storage system, comprising:
a local renewable energy system; and
a control module programmed to estimate an amount of renewable energy expected to be generated by the local renewable energy system over a predefined time period based on a crowd sourced renewable power generation data and a weather data.

2. The system as recited in claim 1, wherein the local renewable energy system includes at least one solar panel.

3. The system as recited in claim 1, wherein the crowd sourced renewable power generation data is received from a crowd sourced database of a cloud-based server system.

4. The system as recited in claim 3, wherein the weather data is received from a weather database of cloud-based server system.

5. The system as recited in claim 4, wherein the weather data includes at least a speed and a direction of wind or an amount of cloud coverage.

6. The system as recited in claim 1, wherein the control module is further programmed to prepare a charging/discharging schedule for transferring energy from the local renewable energy system.

7. The system as recited in claim 6, wherein the charging/discharging schedule is at least partially derived based on the amount of renewable energy expected to be generated by the local renewable energy system over the predefined time period.

8. The system as recited in claim 7, wherein the charging/discharging schedule is further derived based on a total energy need of a structure associated with the local renewable energy system.

9. The system as recited in claim 6, wherein the charging/discharging schedule includes instructions for charging a vehicle of the system.

10. The system as recited in claim 1, wherein the control module is further configured to create a vehicle operating schedule for operating a vehicle of the system.

11. The system as recited in claim 10, wherein the vehicle operating schedule includes a target departure time for leaving a home location of the vehicle and a target return time for returning to the home location.

12. The system as recited in claim 11, wherein the control module is programmed to select the target departure time during a period of time in which the amount of renewable energy expected to be generated by the local renewable energy system exceeds a predefined threshold.

13. A vehicle-to-home power supply and energy storage system, comprising:
a vehicle including a traction battery pack; and
a control module programmed to schedule a drive route of the vehicle to occur during a time period in which an estimated renewable energy generation of a local renewable energy system is expected to exceed a predefined threshold.

14. The system as recited in claim 13, wherein the control module is an on-board component of the vehicle.

15. The system as recited in claim 13, wherein the estimated renewable energy generation of the local renewable energy system is derived from a crowd sourced renewable power generation data.

16. The system as recited in claim 15, wherein the estimated renewable energy generation of the local renewable energy system is further derived from a weather data.

17. The system as recited in claim 16, wherein the weather data includes wind information or cloud coverage information.

18. The system as recited in claim 13, wherein the control module is programmed to identify a target departure time for the vehicle to travel away from a home location of the vehicle and a target return time for the vehicle to return to the home location as part of scheduling the drive route.

19. The system as recited in claim 18, wherein the control module is programmed to identify a charging location along the drive route as part of scheduling the drive route.

20. The system as recited in claim 13, wherein the time period correlates to a period of relatively low cloud coverage at a location of the local renewable energy system.
